(19) United States
(12) Patent Application Publication
(10) Pub. No.: US 2025/0231059 A1
(43) Pub. Date: Jul. 17, 2025

(54) LEVEL INDICATOR SYSTEM USING LIGHTS

(71) Applicant: Noah Champy, Flowery Branch, GA (US)

(72) Inventor: Noah Champy, Flowery Branch, GA (US)

(21) Appl. No.: 19/026,186

(22) Filed: Jan. 16, 2025

Related U.S. Application Data
(60) Provisional application No. 63/621,580, filed on Jan. 16, 2024.

(51) Int. Cl. G01F 23/00; F21S 4/28; F21V 15/01; F21Y 113/13; F21Y 115/10; H05B 47/105

(52) U.S. Cl. CPC G01F 23/0007; F21S 4/28; F21V 15/01; H05B 47/105; F21Y 2113/13; F21Y 2115/10

(57) ABSTRACT

Implementations of a level indicator system using lights to visually represent the level of liquid or non-liquid and/or location of one or more instruments/equipment in a tank are provided.

### CROSS REFERENCE TO RELATED APPLICATION

This application claims the benefit of U.S. Patent Application Ser. No. 63/621,580, which was filed on Jan. 16, 2024, and is incorporated herein by reference in its entirety.

### TECHNICAL FIELD

This disclosure relates to implementations of a level indicator system using lights.

### BACKGROUND

Large, vertical tanks (e.g., a 12,000-gallon tank) are typically used for storing large volumes of liquids. FIG. 1 illustrates an implementation of an example tank 100. The specific use of these tanks can vary depending on the industry and the type of liquid being stored. For example, these tanks may be used in wastewater treatment facilities for the storage of sewage or other wastewater before processing. These tanks may also be used to house chemicals, other liquids, or non-liquid products.

Knowing the volume or level of liquid or non-liquid product in a tank is important for many reasons. For example, knowing the level of a product (liquid or non-liquid) in a tank helps prevent overfilling and spills. As another example, knowing the level of a product in a tank can help to plan routine maintenance (e.g., tank cleaning, repairs, or equipment upgrades) and inspections.

Determining the volume or level of liquid or non-liquid product in a tank can be done using various devices including, but not limited to, float gauges, ultrasonic level sensors, radar sensors, and pressure sensors. FIG. 2 illustrates an implementation of a mechanical level indicator 200. A sight glass level indicator is a transparent or translucent tube or window installed on the side of a tank that allows visual inspection of the liquid level inside the tank. FIG. 3 illustrates an implementation of a sight glass level indicator 300.

However, existing methods of visually indicating the level of liquid or non-liquid product in a tank have disadvantages. For example, a sight glass requires penetration of the side of the tank which can cause leak points. The float gauges are less accurate and can be difficult to read. Ultrasonic level sensors are easy to install and are highly accurate, however, there is no adequate visual representation of the level of liquid or non-liquid product in a tank measured by an ultrasonic level sensor.

### BRIEF DESCRIPTION OF THE DRAWINGS

FIG. 1 illustrates an implementation of an example tank.

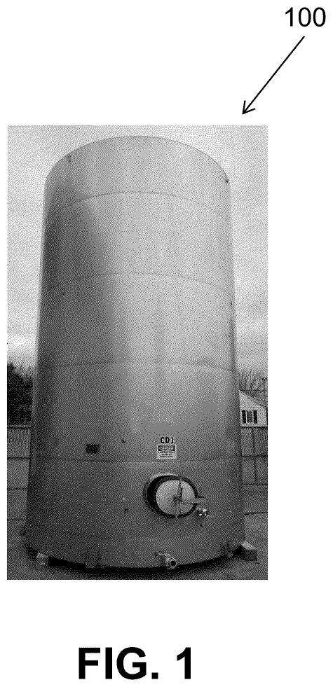

FIG. 2 illustrates an implementation of a mechanical level indicator.

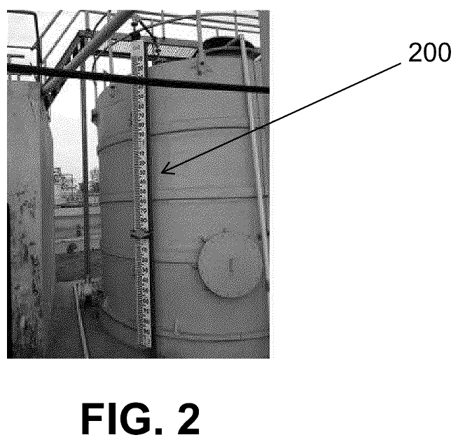

FIG. 3 illustrates an implementation of a sight glass level indicator.

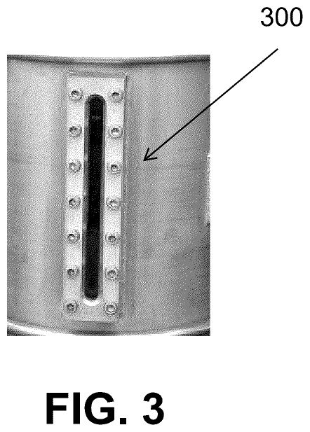

FIG. 4 illustrates an implementation of an example level indicator system according to the present disclosure.

FIG. 5 illustrates an implementation of an example lighting mechanism using Flexible Chip on Board (FCOB) technology.

### DETAILED DESCRIPTION

Implementations of a level indicator system using lights to visually represent the level of liquid or non-liquid and/or location of one or more instruments/equipment in a tank are provided.

In some implementations, a tank of the present disclosure is a stationary tank. In some implementations, the tank of the present disclosure is a stationary tank that sits on a concrete platform. In some implementations, the tank of the present disclosure is a large, vertical tank. In some implementations, the tank of the present disclosure is at least a 12,000-gallon vertical tank. In some implementations, the tank of the present disclosure is less than 12,000-gallon. In some implementations, the level indicator system can be used on mixers having agitators.

In some implementations, a level indicator system of the present disclosure comprises a level measuring device configured to measure the level of liquid or non-liquid in a tank, a lighting mechanism configured to visually represent the level measured, and a controller configured to control the lighting mechanism based on the level measured by the level mechanism.

In some implementations, the level measuring device comprises an ultrasonic level sensor configured to measure the level of liquid or non-liquid in a tank. In some implementations, the level measuring device may comprise a radar sensor or any other suitable device configured to measure the level of liquid or non-liquid in a tank. Those of ordinary skill in the art know of other devices for measuring the volume or level of liquid or non-liquid product in a tank. Any present of future-existing device configured to measure the level of liquid or non-liquid in a tank may be used.

In some implementations, a lighting mechanism comprises a light strip configured to visually represent the level measured by the level measuring device. In some implementations, the light strip comprises lights evenly spaced along an elongated substrate.

In some implementations, the substrate is flexible. In some implementations, the substrate is stiff or rigid. In some implementations, the substrate is semi-flexible. In some implementations, the substrate is configured to have enough give or bend such that the substrate does not break as a tank to which it is attached expands and contracts.

In some implementations, the light strip comprises a plurality of addressable zones or segments (“zones”). In some implementations, the zones are 5 cm in length. In some implementations, the zones are greater than 5 cm in length. In some implementations, the zones are less than 5 cm in length.

In some implementations, the zones are defined by hardware. In some implementations, the zones are defined by software.

In some implementations, each zone of the light strip comprises one or more lights configured to be controlled by hardware and/or software controllers. In some implementations, each light in each segment may be configured to be independently controlled. In some implementations, a group of lights in each segment may be configured to be controlled independently.

In some implementations, the lights of the light strip are light emitting diodes (LEDs). In some implementations, the lights are miniature incandescent bulb. In some implementations, the lights are any other suitable lights.

In some implementations, the light strip comprises a Flexible Chip on Board (FCOB) technology. In this way, light strip produces a smooth, uniform light output without noticeable dots.

In some implementations, the light strip is encased in a transparent polyvinyl chloride (PVC) tube or suitable transparent tube.

In some implementations, the controller comprises a microcontroller. In some implementations, the controller comprises a programmable logic controller (PLC). In some implementations, the controller comprises an LED control circuit.

In some implementations, a light strip is placed down the side of a tank and secured to a tank.

In some implementations, the light strip is secured to the tank using a suitable adhesive, connectors, or any other suitable means. In some implementations, the light strip is welded to the tank.

In some implementations, controller is programmed to control the light strip to activate certain lights or zones based on the level measured by the level measuring device. For example, in some implementations, the controller is programmed to control the light strip to activate a certain number of sequential lights based on the level of the liquid or non-liquid measured by the level measuring device.

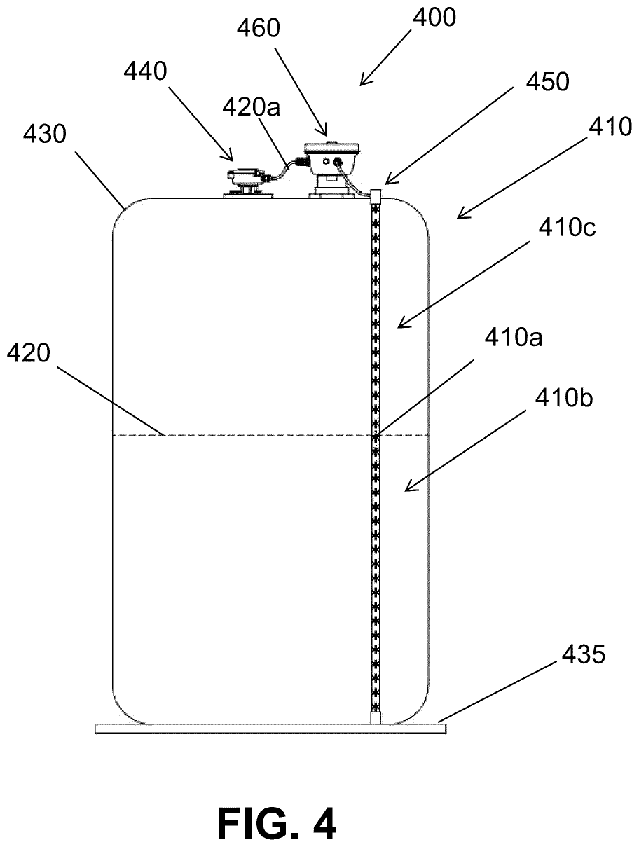

FIG. 4 illustrates an implementation of an example prototype of a level indicator system 400 according to the present disclosure.

As discussed above, implementations of a level indicator system (e.g., 400) use lights (e.g., 410) to visually represent the level 420 of liquid or non-liquid and/or location of one or more instruments/equipment in a tank 430.

In some implementations, a level indicator system 400 comprises a level measuring device (e.g., 440) configured to measure the level 420 of liquid or non-liquid in a tank, a lighting mechanism (e.g. 450) configured to visually represent the level measured by the level measuring device, and a controller 460 configured to control the lighting mechanism based on the level measured by the level measuring device.

As discussed above, in some implementations, the tank 430 is a stationary tank. In some implementations, the tank 430 is a stationary tank that sits on a concrete platform 435. In some implementations, the tank 430 is a large, vertical tank. In some implementations, the tank 430 is at least a 12,000-gallon vertical tank. In some implementations, the tank 430 is less that 12,000-gallon.

In some implementations, the level measuring device comprises an ultrasonic level sensor 440 configured to measure the level 420 of liquid or non-liquid in the tank 430.

In some implementations, a lighting mechanism comprises a light strip 450 configured to visually represent the level measured 420a by the level measuring device 440. In some implementations, the light strip 450 comprises lights 410 evenly spaced along an elongated substrate.

As discussed above, in some implementations, the substrate is flexible. In some implementations, the substrate is stiff or rigid. In some implementations, the substrate is semi-flexible. In some implementations, the substrate is configured to have enough give or bend such that the substrate does not break as a tank to which it is attached expands and contracts.

In some implementations, the light strip 450 comprises a plurality of addressable zones or segments (“zones”). In some implementations, the zones are 5 cm in length. In some implementations, the zones are greater than 5 cm in length. In some implementations, the zones are less than 5 cm in length.

In some implementations, the zones are defined by hardware. In some implementations, the zones are defined by software.

In some implementations, each zone of the light strip 450 comprises one or more lights configured to be controlled by hardware and/or software controllers. In some implementations, each light in each segment may be configured to be independently controlled. In some implementations, a group of lights in each segment may be configured to be controlled independently.

In some implementations, the lights 410 of the light strip 450 are light emitting diodes (LEDs). In some implementations, the lights 410 are miniature incandescent bulbs. In some implementations, the lights 410 are any other suitable lights.

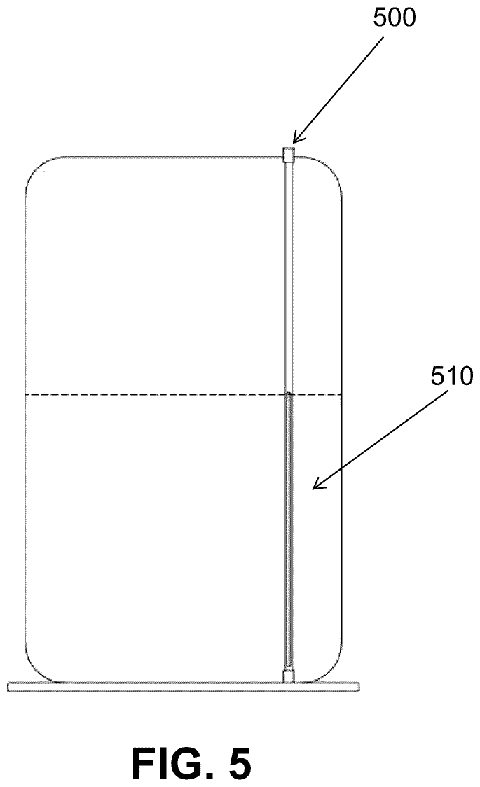

In some implementations, the light strip 450 comprises Flexible Chip on Board (FCOB) technology. FIG. 5 illustrates an implementation of an example lighting mechanism 500 using FCOB technology. In this way, light strip 500 produces a smooth, uniform light output 510 without noticeable dots.

In some implementations, the light strip 450, 500 is encased in a transparent PVC tube or suitable transparent tube.

In some implementations, the controller 460 comprises a microcontroller. In some implementations, the controller 460 comprises a PLC. In some implementations, the controller 460 comprises an LED control circuit.

In some implementations, the light strip 450, 500 is placed down the side of the tank 430 and secured to the tank 430.

In some implementations, the light strip 450, 500 is secured to the tank 430 using a suitable adhesive, connectors, or any other suitable means. In some implementations, the light strip 450, 500 is welded to the tank.

In some implementations, the controller 460 is programmed to control the light strip 450, 500 to activate certain lights or zones based on the level measured by the level measuring device 440. For example, in some implementations, the controller 460 is programmed to control the light strip 450, 500 to activate a certain number of sequential lights based on the level of the liquid or non-liquid measured by the level measuring device.

In some implementations, the light strip 450, 500 extends from the top of the tank 430 to the bottom of the tank. In some implementations, the light strip 450, 500 extends substantially from the top of the tank to the bottom of the tank. In some implementations, the light strip 450, 500 extends from near the top of the tank to the near the bottom of the tank.

In some implementations, the length of the light strip down the height of the tank is sufficient to provide an accurate representation within an acceptable margin of the area of the interior height of the tank that liquid or non-liquid can occupy. Those of ordinary skill in the art would know the acceptable margin of error. Ideally, the length of the light strip down the height of the tank is close as practical to the interior height of the tank that liquid or non-liquid can occupy. In some implementations, the placement of the light strip on the outer surface of the tank corresponds to the interior height that liquid or non-liquid can occupy.

In some implementations, as shown in FIG. 4, the light 410a corresponding to the topmost surface of the liquid or non-liquid in the tank and all lights 410b below this light 410a are configured to be turned on by the controller 460 to visually indicate the level of liquid or non-liquid in the tank. In some implementations, these lights illuminate a first color.

In some implementations, the lights 410c above the light 410a corresponding to the topmost surface of the liquid or non-liquid in the tank are configured to be turned on and illuminate a second color by the controller 460 to visually indicate the distance between the topmost surface 420 of the liquid or non-liquid and the top of the tank. The first color and the second color are different colors. In some implementations, the light 410a corresponding to the topmost surface of the liquid or non-liquid can be the first color or the second color.

In some implementations, only the light(s) 410a corresponding to the topmost surface of the liquid or non-liquid in the tank is(are) configured to be turned on by the controller 460 to visually indicate the level of liquid or non-liquid in the tank.

In these ways, a level indicator system of the present disclosure can indicate the height of liquid or non-liquid in a tank.

In some implementations, a level indicator system of the present disclosure can indicate the height of liquid or non-liquid in a tank and the distance from the topmost surface of the liquid or non-liquid to the top of the tank.

In some implementations, one or more of the lights can be configured to be one, two, or more different colors to indicate the level of product in a tank, the change in level of product in a tank, remaining height of the tank, or any parameter.

For example, in some implementations, the light corresponding to the highest point of product in a tank since the previous tank fill could be illuminated a third color. In some implementations, the lights between the light corresponding to the current level of product in a tank and the light corresponding to the highest point of the product in the tank since the previous tank fill can be illuminated by a third color.

Thus, the light strip may illuminate three colors. For example, (1) the lights between the light corresponding to the top of the tank and the light corresponding to the highest point of the product in a tank since the previous tank fill can illuminate a first color (e.g., red); (2) the lights between the light corresponding to the highest point of the product in the tank since the previous tank fill and the light corresponding to the current level of the product in the tank can illuminate a second color (e.g., yellow); and (3) the lights between the light corresponding to the current level of the product in the tank and the light corresponding to the bottom of the tank can illuminate a third color (e.g., green).

In some implementations, the level indicator system is configured to transmit the signal from the level measuring device to another device such a PLC that may utilize the signal for processes unrelated to the level indicator system.

In some implementations, one or more of the measuring device, lighting mechanism, and controller may communicate with each other or other devices wirelessly or transmits/receive signals wirelessly.

In some implementations, one or more lights on the light strip also can be used to indicate the height of one or more instruments/equipment inside the tank or mixer. In this way, the level indicator system can indicate the current level of a product in the tank or mixer and the location of instrument(s) or equipment inside the tank or mixer. For example, the light corresponding to the location of an agitator in a mixer can illuminate a distinct color. In this way, the level indicator system can indicate the current level of a product in the mixer and the location of the agitator.

The figures, including photographs and drawings, comprised herewith may represent one or more implementations of a level indicator system of the present disclosure.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A level indicator system comprising:
a level measuring device,
a microcontroller, and
a light strip wherein the microcontroller is programmed to control the light strip to activate a one or a certain number of sequential lights based on a level of product measured by the level measuring device.

2. The level indicator system of claim 1 further comprising a tank or mixer wherein the light strip is placed down the side of the tank or mixer and the microcontroller is programmed to control the light strip to activate one or a certain number of sequential lights based on the level of the product measured by the level measuring device.

3. A level indicator system comprising:
light strip wherein the light strip is placed down the side of a tank or mixer and configured to light up one or a certain number of sequential lights based on the level of product in the tank or mixer.

4. A level indicator system comprising:
lights arranged vertically along the length of a tank or mixer wherein one or a certain number of sequential lights are configured to turn on based on the level of product in the tank or mixer.

5. A method of using the level indicator system of claim 1 comprising turning on the light corresponding to the topmost surface of the product in the tank or mixer.

6. A method of using the level indicator system of claim 1 comprising turning on the light corresponding to the topmost surface of the product in the tank or mixer and all lights below this light to visually indicate the level of product in the tank or mixer.

7. The method of claim 6 wherein the lights illuminate a first color.

8. A method of using the level indicator system of claim 1 comprising turning on the lights above the light corresponding to the topmost surface of the product in the tank to visually indicate the distance between the topmost surface of the product and the top of the tank or mixer.

9. The method of claim 8 wherein the lights illuminate a second color.

10. A method of using the level indicator system of claim 1 comprising turning on one or more lights corresponding to the location of one or more equipment or instruments in a tank or mixer to visually indicate the location of the equipment or instruments inside the tank or mixer.

11. The method of claim 10 wherein the lights illuminate a distinct color.

12. A method of using the level indicator system of claim 1 comprising:
turning on the light corresponding to the topmost surface of the product in the tank or mixer and all lights below this light to visually indicate the level of product in the tank or mixer wherein the lights illuminate a first color; and
turning on one or more lights corresponding to the location of one or more equipment or instruments in a tank or mixer to visually indicate the location of the equipment or instruments inside the tank or mixer wherein the lights illuminate a second color.
